(19) United States
(12) Patent Application Publication
(10) Pub. No.: US 2010/0233892 A1
(43) Pub. Date: Sep. 16, 2010

(54) EXTENDED USB RECEPTACLE AND EXTENDED USB PLUG

(75) Inventor: Han-il KIM, Seoul (KR)

Correspondence Address: H.C. PARK & ASSOCIATES, PLC, 8500 LEESBURG PIKE, SUITE 7500, VIENNA, VA, 22182, US

(73) Assignee: Pantech Co., Ltd., Seoul (KR)

(21) Appl. No.: 12/550,716

(22) Filed: Aug. 31, 2009

(30) Foreign Application Priority Data
Mar. 16, 2009 (KR) 10-2009-0022355

(51) Int. Cl. H01R 13/648; H01R 24/00

(52) U.S. Cl. 439/92; 439/660

(57) ABSTRACT

An extended USB receptacle includes n standard terminals spaced apart from each other, and up to n-1 extended terminals interposed between the n standard terminals and spaced apart from each other. An extended Universal Serial Bus (USB) plug to connect with a USB receptacle includes n standard terminals spaced apart from each other to correspondingly connect with n standard terminals of the USB receptacle, and n-1 extended terminals interposed between the n standard terminals and spaced apart from each other, the n-1 extended terminals to correspondingly connect to n-1 extended terminals of the USB receptacle if the USB receptacle is an extended USB receptacle.

### CROSS-REFERENCE TO RELATED APPLICATION

This application claims priority from and the benefit of Korean Patent Application No. 10-2009-22355, filed on Mar. 16, 2009, which is hereby incorporated by reference for all purposes as if fully set forth herein.

### BACKGROUND OF THE INVENTION

1. Field of the Invention

The following description relates to a Universal Serial Bus (USB) receptacle and plug, and more particularly, to an extended USB receptacle and an extended USB plug that may support extended functions.

2. Discussion of the Background

FIG. 1 shows an example of a conventional 5-pin standard USB receptacle, and FIG. 2 shows an example of a conventional 5-pin standard USB plug.

As shown in FIG. 1, the conventional USB receptacle 100 includes a power (Vcc) terminal 110, a ground (GND) terminal 120, and at least one data terminal 130.

The power (Vcc) terminal 110 may supply power to a USB plug connected with the conventional USB receptacle 100, and may include a positive (+) terminal and a negative (−) terminal. The ground (GND) terminal 120 may ground the USB plug connected with the conventional USB receptacle 100. The at least one data terminal 130 may be for communicating with a device having the USB plug connected with the conventional USB receptacle 100, and may include a transmitting (Tx) terminal 131 for transmitting data to the device via the USB plug, and a receiving (Rx) terminal 132 for receiving data from the device via the USB plug.

As shown in FIG. 2, the conventional USB plug 200 includes n standard terminals to be correspondingly connected with n standard terminals of the conventional USB receptacle 100 shown in FIG. 1.

The conventional USB plug 200 may include a power (Vcc) terminal 210 that may supply or receive power, and that may be correspondingly connected with the power (Vcc) terminal 110 of the USB receptacle 100. A ground (GND) terminal 220 for grounding a device including the conventional USB plug 200 may be correspondingly connected with the ground (GND) terminal 120 of the USB receptacle 100.

At least one data terminal 230 for communicating with the device having the USB receptacle 100 may be correspondingly connected with the at least one data terminal 130 of the USB receptacle 100. Specifically, a transmitting (Tx) terminal 231 for transmitting data may be correspondingly connected with the transmitting (Tx) terminal 131 of the USB receptacle 100, and a receiving (Rx) terminal 232 for receiving data may be correspondingly connected with the receiving (Rx) terminal 132 of the USB receptacle 100.

The USB receptacle 100 may be included with a first device such as a mobile communication terminal, etc., and the USB plug 200 may be included with a second device such as a USB memory device, etc, to be connected with each other.

However, the USB receptacle according to conventional standard and the USB plug connected thereto have no extended functions beyond specified functions such as data transmission/reception through terminals 131, 132, 231, and 232.

### SUMMARY OF THE INVENTION

Exemplary embodiments of the present invention provide an extended USB receptacle and an extended USB plug to connect with a USB receptacle. The extended USB receptacle and extended USB plug may include extended terminals to support extended functions.

Additional features of the invention will be set forth in the description which follows, and in part will be apparent from the description, or may be learned by practice of the invention.

An exemplary embodiment of the present invention discloses an extended USB receptacle including n standard terminals spaced apart from each other; and n-1 extended terminals interposed between the n standard terminals and spaced apart from each other.

An exemplary embodiment of the present invention discloses an extended USB plug to connect with a USB receptacle. The extended USB plug includes n standard terminals spaced apart from each other to correspondingly connect with n standard terminals of the USB receptacle; and n-1 extended terminals interposed between the n standard terminals and spaced apart from each other, the n-1 extended terminals to correspondingly connect to n-1 extended terminals of the USB receptacle if the USB receptacle is an extended USB receptacle.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 shows an example of a conventional 5-pin standard USB receptacle.

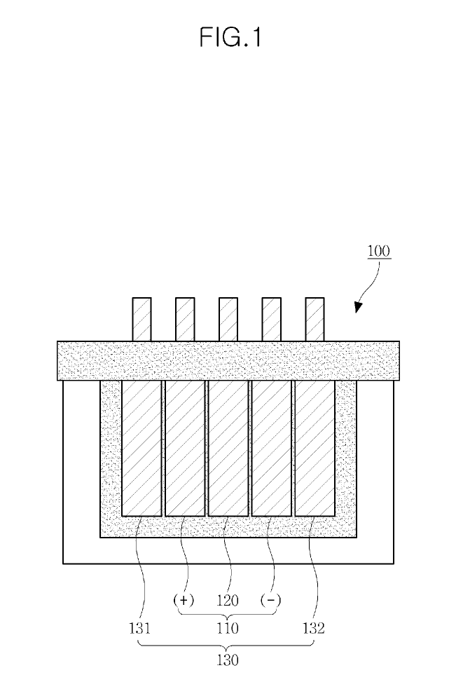

FIG. 2 shows an example of a conventional 5-pin standard extended USB plug.

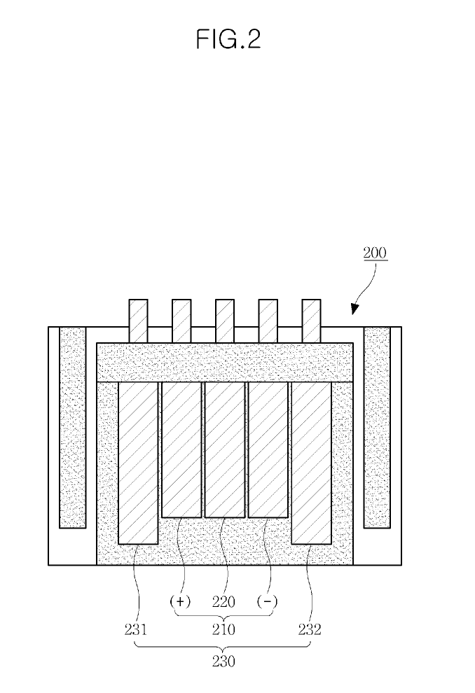

FIG. 3 is a view of an extended USB receptacle in accordance with an exemplary embodiment of the present invention.

FIG. 4 is a view of an extended USB plug in accordance with an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the sizes and relative sizes of layers and regions may be exaggerated for clarity. Like reference numerals in the drawings denote like elements.

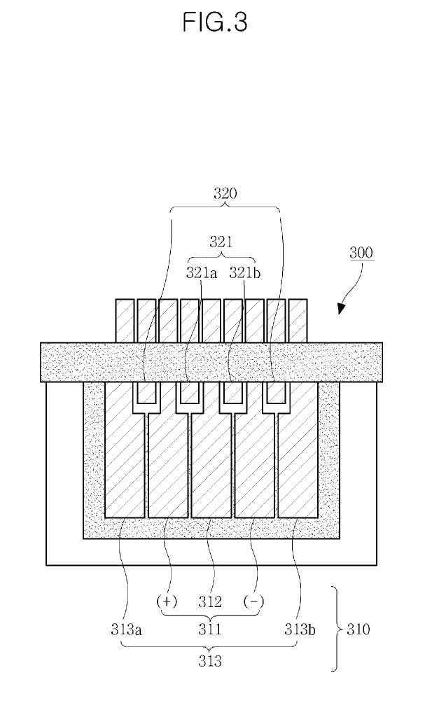

FIG. 3 is a view of an extended USB receptacle in accordance with an exemplary embodiment of the present invention. As shown, the extended USB receptacle 300 includes n standard terminals 310 spaced apart from each other, and n-1 extended terminals 320 interposed and alternating between the n standard terminals 310 and spaced apart from each other.

The n standard terminals 310 may include a power (Vcc) terminal 311, a ground (GND) terminal 312, and at least one first data terminal 313. The power (Vcc) terminal 311 may supply power to a USB plug connected with the extended USB receptacle 300, and may include a positive (+) terminal and a negative (−) terminal. The ground (GND) terminal 312 may ground the USB plug connected with the extended USB receptacle 300.

The at least one first data terminal 313 may be for communicating with a first external device (not shown) having the USB plug connected with the extended USB receptacle 300, and may include a transmitting (Tx) terminal 313a to transmit data to the first external device having the USB plug connected with the extended USB receptacle 300, and a receiving (Rx) terminal 313b to receive data from the first external device having the USB plug connected with the extended USB receptacle 300.

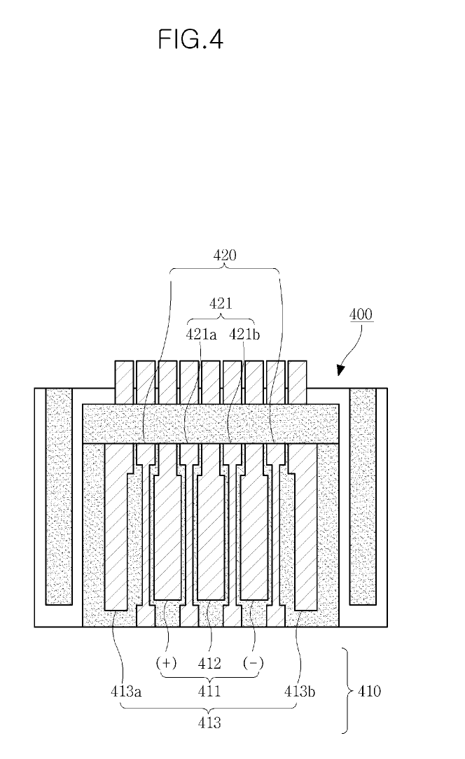

As noted above, the extended USB receptacle 300 also includes n-1 extended terminals 320. The extended terminals 320 may include at least one second data terminal 321. The at least one second data terminal 321 may be for communicating with the first external device including the USB plug if the USB plug of the first external device has capabilities to connect to the n-1 extended terminals 320. An example of such a USB plug is described in more detail below with reference to FIG. 4. The at least one second data terminal 321 may include at least a transmitting (Tx) terminal 321a to transmit data to the first external device including the USB plug connected to the USB receptacle 300, and a receiving (Rx) terminal 321b to receive data from the first external device including the USB plug connected to the USB receptacle 300.

If the USB plug included in the first external device and connected with the extended USB receptacle 300 is a conventional USB plug 200, the n-1 extended terminals 320 may not contact the terminals of the conventional USB plug 200. Thus, the n-1 extended terminals 320 of the extended USB receptacle 300 may not be compatible with the conventional USB plug 200. However, the n standard terminals 310 may be compatible with the conventional USB plug 200.

However, if the USB plug included in the first external device and connected with the extended USB receptacle 300 is an extended USB plug 400, which will be described below, the extended terminals and standard terminals of the extended USB plug 400 may contact the n-1 extended terminals 320 and the n standard terminals 310, respectively. Thus, it is possible to use extended functions so that more various applications may be applied.

The extended USB receptacle 300 may be installed at a mobile communication terminal, and devices that may support functions compatible with only the conventional USB standard, such as a USB memory device having a conventional standard USB plug, may be connected with the n standard terminals 310 of the extended USB receptacle 300 and used.

In addition, devices having an extended USB plug 400 with terminals that contact both the n standard terminals 310 and the n-1 extended terminals 320 of the extended USB receptacle 300, for example, extended application devices, such as test instruments such as JTAG as a debugger for development of an embedded system, may be connected with the extended USB receptacle 300 and used. Thus, it may be possible to apply more applications by using an extended USB plug 400 with an extended USB receptacle 300.

FIG. 4 is a view of an extended USB plug in accordance with an exemplary embodiment of the present invention. The extended USB plug 400 shown in FIG. 4 includes n standard terminals 410 spaced apart from each other to be correspondingly connected with n standard terminals 310 of the extended USB receptacle 300, and n-1 extended terminals 420, interposed and alternating between the n standard terminals 410 and spaced apart from each other, to be correspondingly connected to the n-1 extended terminals 320 of the extended USB receptacle 300.

The extended USB plug 400 is an extended USB plug the may support both a USB standard compatible function and an extended function. The n standard terminals 410 may include a power (Vcc) terminal 411, a ground (GND) terminal 412, and at least one first data terminal 413. These n standard terminals 410 may be connected to the corresponding standard terminals of a conventional USB receptacle 100. Additionally, these n standard terminals 410 may be connected to standard terminals of an extended USB receptacle 300 as described in more detail below.

The power (Vcc) terminal 411 may be connected with the power (Vcc) terminal 311 of the standard terminal 310 of the extended USB receptacle 300, and may include a positive (+) terminal and a negative (−) terminal. Thus, power may be received from an external device (not shown) having the extended USB receptacle 300 through the power (Vcc) terminal 411.

The ground (GND) terminal 412 may be connected with the ground (GND) terminal 312 of the extended USB receptacle 300.

The at least one first data terminal 413 may be connected with the at least one first data terminal 313 of the extended USB receptacle 300 to communicate with a device (not shown) having the extended USB receptacle 300 through the at least one first data terminal 413.

Specifically, the at least one first data terminal 413 may include a transmitting (Tx) terminal 413a to connect with the transmitting (Tx) terminal 313a of the extended USB receptacle 300 for transmitting data, and a receiving (Rx) terminal 413b to connect with the receiving (Rx) terminal 313b of the extended USB receptacle 300 for receiving data.

The n-1 extended terminals 420 of the extended USB plug 400 may include at least one second data terminal 421. The at least one second data terminal 421 may be connected with the at least one second data terminal 321 of the extended USB receptacle 300 to communicate with the device having the extended USB receptacle 300 through the at least one second data terminal 421.

The at least one second data terminal 421 may include a transmitting (Tx) terminal 421a to connect with the transmitting (Tx) terminal 321a of the extended USB receptacle 300 for transmitting data, and a receiving (Rx) terminal 421b to connect with the receiving (Rx) terminal 321b of the extended USB receptacle 300 for receiving data.

Therefore, if the extended USB plug 400 is connected with the extended USB receptacle 300, the n-1 extended terminals 420 and the standard terminals 410 of the extended USB plug 400 may respectively contact the n-1 extended terminals 320 and the n standard terminals 310 of the extended USB receptacle 300. Thus, the extended function may be used to apply more various applications than the conventional art.

For example, the extended USB plug 400 may be included with an application device such as a test instrument, for example, JTAG as a debugger for development of an embedded system, and it may be connected to an extended USB receptacle 300 and used to apply more applications than the conventional art.

Although the extended USB receptacle 300 and extended USB plug 400 are shown to include n-1 extended terminals 320 and 420, respectively, the extended USB receptacle 300 and extended USB plug 400 may each include fewer than n-1 extended terminals 320 and 420, respectively. For example, if n equals 5, the extended USB receptacle 300 and extended USB plug 400 may each include 1, 2, or 3 extended terminals 320 and 420, respectively. Alternatively, the may each include 4 extended terminals 320 and 420, respectively, but fewer than 4 extended terminals 320 and 420 may be used to apply more applications relative to the conventional art.

As can be seen from the foregoing, more applications may be applied through the extended USB receptacle and the extended USB plug connected with the extended USB receptacle, which may be compatible with the conventional USB standard while providing extended functions.

Therefore, the present invention may be industrially used in technical fields related to USBs and their applications.

It will be apparent to those skilled in the art that various modifications and variations may be made in the present invention without departing from the spirit or scope of the invention. Thus, it is intended that the present invention covers the modifications and variations of this invention provided they come within the scope of the appended claims and their equivalents.

What is claimed is:

1. An extended Universal Serial Bus (USB) receptacle, comprising:
n standard terminals spaced apart from each other; and
n-1 extended terminals interposed between the n standard terminals and spaced apart from each other.

2. The extended USB receptacle of claim 1, wherein the n standard terminals comprise:
a power (Vcc) terminal to supply power;
a ground (GND) terminal; and
a data terminal to communicate with a device.

3. The extended USB receptacle of claim 2, wherein the data terminal comprises a transmitting (Tx) terminal to transmit data to the device, and a receiving (Rx) terminal to receive data from the device.

4. The extended USB receptacle of claim 1, wherein the n-1 extended terminals comprises a first data terminal to communicate with a device.

5. The extended USB receptacle of claim 4, wherein the first data terminal comprises a transmitting (Tx) terminal to transmit data to the device and a receiving (Rx) terminal to receive data from the device.

6. The extended USB receptacle of claim 5, wherein the first data terminal transmits data to and receives data from the device via a second data terminal of a USB plug of the device.

7. The extended USB receptacle of claim 6, wherein the second data terminal of the USB plug of the device is an extended terminal.

8. The extended USB receptacle of claim 1, wherein n is a whole number equal to 2, 3, 4, or 5.

9. The extended USB receptacle of claim 1, wherein the n-1 extended terminals are arranged to alternate with the n standard terminals.

10. The extended USB receptacle of claim 1, wherein the n-1 extended terminals are separated from standard terminals of a USB receptacle connected with the extended USB receptacle.

11. An extended Universal Serial Bus (USB) plug to connect with a USB receptacle, the extended USB plug comprising:
n standard terminals spaced apart from each other to correspondingly connect with n standard terminals of the USB receptacle; and
n-1 extended terminals interposed between the n standard terminals and spaced apart from each other, the n-1 extended terminals to correspondingly connect to n-1 extended terminals of the USB receptacle if the USB receptacle is an extended USB receptacle.

12. The extended USB plug of claim 11, wherein the n-1 extended terminals comprise a first data terminal to connect with a second data terminal of the n-1 extended terminals of the extended USB receptacle.

13. The extended USB plug of claim 12, wherein the first data terminal comprises a transmitting (Tx) terminal to transmit data and a receiving (Rx) terminal to receive data via the second data terminal of the extended USB receptacle.

14. The extended USB plug of claim 11, wherein n is a whole number equal to 2, 3, 4, or 5.

15. The extended USB plug of claim 11, wherein the n-1 extended terminals of the extended USB plug are arranged to alternate with the n standard terminals of the extended USB plug.
